(19) United States
(12) Patent Application Publication
(10) Pub. No.: US 2002/0170680 A1
(43) Pub. Date: Nov. 21, 2002

(54) Lamination apparatus

(76) Inventors: Yasuhiro Shimizu, Tatsuno-shi (JP); Masaki Takeuchi, Tatsuno-shi (JP); Yasuaki Matsui, Tatsuno-shi (JP); Masaki Koroyasu, Tatsuno-shi (JP); Akira Okuno, Osaka (JP); Katsushige Tsukuya, Osaka (JP); Daimon Ueda, Osaka (JP)

Correspondence Address: DELLETT AND WALTERS, 310 S.W. FOURTH AVENUE, SUITE 1101, PORTLAND, OR, 97204, US

(21) Appl. No.: 10/081,877

(22) Filed: Feb. 22, 2002

(30) Foreign Application Priority Data
Feb. 28, 2001 (JP) 2001-055681

(51) Int. Cl. B32B 31/00

(52) U.S. Cl. 156/378; 156/555

(57) ABSTRACT

The lamination apparatus of this invention enables the operator to keep working without paying attention to the remaining length of the laminating film. The lamination apparatus is used to make lamination layers with a transparent or semitransparent laminating film pasted on such printed matters as posters, advertising fliers or computer output media. The laminate apparatus comprise the following systems and units. Measuring system containing encoder 13 to measure the length of laminate film A pulled out from original roll. Input system 16 for the length of laminate film A set in advance. Calculation system to subtract pulled-out length of laminate film A from that of the original film roll 4. Display unit 17 to indicate the subtracted value of laminate film. Alarm system for issuing a warning when the subtracted value reaches some certain level or less.

### BACKGROUND OF THE INVENTION

1. Field of the Invention

This invention relates to the lamination apparatus being used to make lamination layers with transparent or semitransparent laminate films spreading adhesive agents on one side of the surfaces and pasted on such printed matters as posters, advertising fliers or computer output media (simply called as media hereinafter) in order to improve water and weather resistance.

2. Prior Art

The original roll of laminate film is a long sheet of lamination layers wound around the paperboard tube. Such lamination layers are composed of transparent or semitransparent film of polyester or vinyl chloride with adhesive agent on one side of the surface and detachable paper stuck on it.

The conventional apparatus to coat the surface of the media with a laminate film stuck on, has side plates 11 fixed parallel to each other in both right and left sides of support frames as shown in the side view of FIG. 2. The side plates 11 are supporting structure for bearings which hold a shaft 31 of a carry roller 3, a shaft 41 of an original roll 4 of laminate film A, a shaft 51 of an original roll 5 of a carrier film C, a shaft 42 of a roll to wind a sheet of pattern paper B detached from the laminate film A and a shaft of an idler roller 43.

Furthermore, a table 2 by which media M are sent to is supported inside of the side plates 11, and a shaft of an idler roller 21 is supported by bearings also inside of the side plates 11.

The carry roller 3 which is supported by both of the right and left side plates is driven by a motor 31, and a pressure roller 6 is installed on the carry roller 3 to make a pair each other.

The shaft of pressure roller 6 is supported by bearings installed in the movable plates 61. One end of the movable plates 61 is supported by an axis 62 installed in the side plates 11. The other end of the movable plates 61 can be moved up and down by a rod 65 and a cam 64 turned by a lever 63 in order to keep distance between the pressure roller 6 and the carry roller 3. Pressure force to pressure roller is given by a spring 66. Pressure force is adjusted by a handle 68 with turning a threaded rod 67.

Upon the pressure roller 6 being moved by the operator apart away from the carry roller 3 with the lever 63, the original roll 5 of the carry film C is set on the shaft 51 followed by such carry film C being inserted in the space between the carry roller 3 and the pressure roller 6 passing through an idler roller 21 and the table 2. Laminate film with exposed adhesive surface passes through the carry roller 3 and the pressure roller 6 together with the carry film C followed by the pressure roller 6 lowered with the lever 63. On the other hand, the pattern sheet of paper B peeled off the laminate film A after setting of the original roll 4 of the laminate film A is wound around the rod supported on the shaft 42 through the idler roller 43.

The operator places media M on the carry film C covering the surface of the table 2. And he steps on the foot switch of the motor 30 for revolution to be transmitted to the carry roller 3 and the shaft 42 of the roll for rewinding sheet of pattern paper B. Media M is pulled together with the carry film C by revolving the carry roller 3 into the space between the pressure roller 6 and the carry roller 3. On that occasion, laminate film A with exposed adhesive surface is supplied along the surface of the pressure roller 6 to be pasted on the surface of media M and discharged on the tilted table 8 at the back side. Sheet of pattern paper B stripped off is rewound around the roll supported on the shaft 42.

As mentioned above, laminate film is placed on the media M upon being pulled out of the original roll 4 of laminate film A. However the conventional lamination apparatus is not furnished with such system as to measure the length of laminate film consumed. This might cause the long media M to be wasted due to unexpected shortage of the remained laminate film A before completion of the job.

In addition, the conventional apparatus might cause much difficulty in verifying the remained length of the laminate film A of the original roll 4 when replaced by another one.

Furthermore, the laminate film A and media M might crease due to inertia of the pressure roller 6, the roll 4 of laminate film A and the roll 5 of the carry film C that occur in case of sudden start and/or sudden stop of motor, because the carry roller 3 only is driven by the motor 30 for the conventional lamination apparatus.

### SUMMARY OF THE INVENTION

Those problems to be resolved as mentioned above have lead to invention of new apparatus. The invented apparatus aims at continuation of the work without paying attention to the remaining length of laminate film A of the original roll 4 because of the display system furnished to indicate always the remainder of laminate film A of the original roll 4 and a warning issued for the designated length of the remainder or less. Moreover, slow start and slow stop system is employed for operation of the motor 30 in order to prevent the laminate film A and media M from having creases.

The invented apparatus forms laminated layer with a laminate film on the computer output media and printed matters such as posters and advertising fliers. The apparatus is furnished with the following particular systems or units.

1. Measuring system for the length of laminate film pulled out from the original roll.

2. Input system for the length of laminate film set in advance.

3. Calculation system to subtract the pulled out length of laminate film from that of the original roll.

4. Display unit to indicate the subtracted value of laminate film.

5. Alarm system to issue a warning when such a subtracted value reaches some certain level or less.

Meanwhile, computer output media and or such printed matters as posters and advertising fliers are passing together with laminate film one on top of the other through the carry roller and the pressure roller in order to form lamination layers. The motor to drive the carry roller is furnished with such speed control systems as giving slow start and slow stop.

### BRIEF DESCRIPTION OF THE DRAWINGS

FIG. 1 is block diagrams for explanation of the principle of the invented lamination apparatus.

FIG. 2 is explanatory side view of the conventional lamination apparatus.

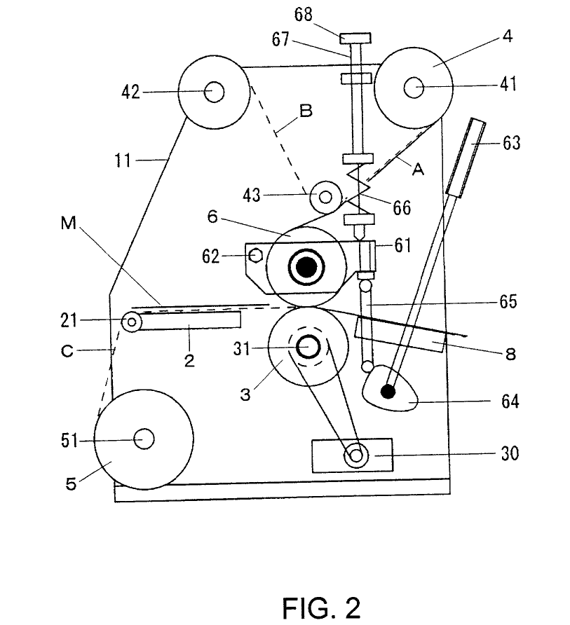

Symbols mean as follows: B: Peeled off pattern paper, C: Carry film, M: Media, 2&8: Table, 3: Carry roller, 4: Original roll of lamination film, 5: Original roll of carry film, 6: Pressure roller, 21&43: Idler roller, 13: Encoder, 15: Main processing unit, 16: Operation unit, 17: Display unit, 18: Foot switch, 19: Motor control system, 30: Motor.

### DESCRIPTION OF THE PREFERRED EMBODIMENTS

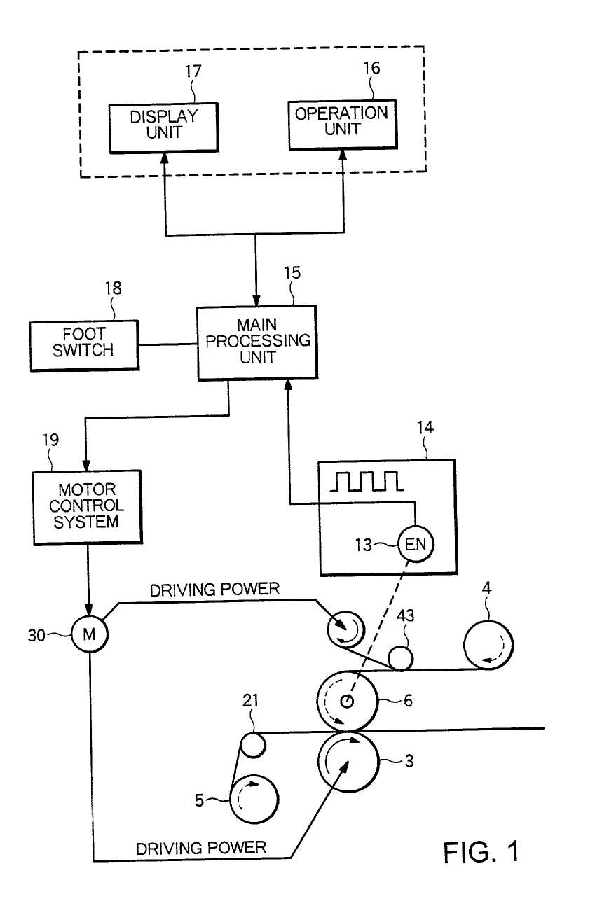

The invented lamination apparatus is furnished with the control system having CPU as shown in FIG. 1. The control system is composed of the following parts.

1. Measurement unit 14 having a encoder 13 fixed to a shaft of pressure roll 6.

2. Main processing unit 15 with CPU counting pulse signals outputting from the encoder 13.

3. Operation unit 16 instructing speed and direction of the motor revolution and inputting length of the laminate film A of original roll 4 to the main processing unit.

4. Display unit 17 to indicate the remainder length of laminate film A of the roll 4, speed and direction of revolution of a motor 30, and warning signals.

5. Control unit 19 for operation of the motor 30.

The installed footswitch 18 controls operation of the motor 30 as follows. The motor turns round should the footswitch be step on in pause of operation of the motor, while the motor comes to stop should such footswitch be step on during the motor running. And also the motor can be controlled to keep running for the period of the footswitch 18 being step on.

The motor control unit 19 makes a slow start and/or a slow stop of the motor 30 in order to maintain smooth work without excessive tension or slack of films and other materials that may be caused by great inertia of the carry roller 3, the pressure roller 6, the roll 14 of laminate film A and the roll 5 of carry film C.

The motor can be turned over if reverse revolution of the motor is required due to some operational trouble.

The invented lamination apparatus system is applied in order to affix laminate film A on media M according to the following procedure.

As same as for the conventional lamination apparatus, the original roll 4 of the laminate film A and the original roll 5 of the carry film C are set followed by the carry film C inserted in the space between the carry roller 3 and the pressure roller 6 through the idler roller 21 and the table 2. On the other hand, the pattern sheet B peeled off the laminate film A is rewound around the roll core supported by the shaft 42 through the idler roller 43. The laminate film A with adhesive surface exposed is inserted together with the carry film C in the space between the carry roller 3 and the pressure roller 6.

Initial input of original length of the roll is made on the operation unit 16 (e.g. 50 m length of roll or 100 m length of roll) upon the original roll 4 of laminate film A being set. Since the laminate film A is pulled out to the space between the carry roller 3 and the pressure roller 6, useless length of laminate film is unavoidable (e.g. 20 cm). After subtraction of such lost length the value of length is indicated on the display as remainder of the laminate film A. The value of lost length can be kept in memory in advance. Or the length inclusive of such lost one can be input on the operation unit 16 at the time of setting. Revolution speed of the motor 30 and the value of the remainder of length (e.g. 3 m) for alarm is input. Since the purpose cannot be achieved without inputting of length of the remainder for alarm, such length can be kept in memory so that nobody is allowed to make input later. Under the plural values for remainder length (e.g. 10 m, 5 m, and 2.5 m) alarms can be set in order to issue different warnings each other for respective remainder length cases with the more emphasized warning for the less length of the remainder.

Media M is placed on the carry film C with the front edge of media M adjusted to the straight line drawn in parallel with the rotation axis 31 of a carry roller C (not shown herein) on the surface of the table 2. Upon stepping on the foot switch 18, the motor 30 makes a slow start and at preset speed rotates the carry roller 3 and the roll shaft for peeled off paper pattern B being wound around. Media M together with the carry film C is pulled into the space between the carry roller 3 and the pressure roller 6 by rotating the carry roller 3. Then laminate film A supplied along the surface of pressure roller 6 is pasted on the surface of media M with adhesive surface exposed and discharged on the inclined table 8 at the back.

The continuous operation for plural media M is as follows. Upon the end of preceding media M passing through the space between the carry roller 3 and the pressure roller 6, the foot switch 18 is stepped on for slow stop of the motor 30, and the front edge of succeeding media M is adjusted to the straight line on the table 2. Upon the foot switch 18 being stepped on again, the work resumes for the surface of succeeding media M being pasted with laminate film A and then discharged on the inclined table 8 at the back.

The laminate film stuck out of media M is discharged on the inclined table 8 at the back together with the carry film C pasted on each other. Cutting of laminate film A adjusted to the outline of the media M yields laminated layer of media M with much more improved water and weather resistance.

During the operation pulse signals are output from the encoder 13 connected to the shaft of the carry roller 3. Counting of the pulses gives the length of consumed laminate film A and the remainder of laminate film A is obtained by subtraction of consumed length from the original one set at first. The remainder of laminate film A is indicated on the display 17. Should the remainder reach the designated value or less warning is issued by means of sound or light.

If the original roll 4 of laminate film A is replaced by another one before complete consumption, a memo of remainder indicated on the display 17 should be attached to the removed original roll in advance. In case of reset of the removed one the remainder can be indicated on the display, through input of the remainder on the operation unit 16 as the initial value of the original roll.

According to the embodiment as explained above, the followings are obvious effects obtained. Since the invented lamination apparatus indicates the remainder of the laminate film A of the original roll 4 and issues a warning when the remainder reaches the designated value or less.

1. The operator can proceed with the work without paying any attention to the remainder of laminate film A.

2. The apparatus of this invention can prevent such bad quality as the laminate film A being pasted on a part of media due to shortage of it caused when the original roll 4 finished.

Furthermore, slow start and/or slow stop of the motor 30 can keep off laminate film A and media M from having creases, which may lead to inferior goods.

What is claimed is:

1. Lamination apparatus to make lamination layers with a laminate film pasted on the surfaces of such printed matters as posters, advertising fliers and computer output, comprising:
a means to measure the length of the laminate film drawn out of the original roll,
a means to input the whole length of the roll of laminate film,
a means to subtract the measured values of drawn out the laminate film from the length of the original roll,
a display system to indicate such subtracted values, and
an alarm system to issue a warning in case that such subtracted value reaches the designated level or less.

2. Lamination apparatus containing the speed control system to give slow start and slow stop to the motor which drives the carry roller in order to convey such printed matters as posters, advertising fliers and computer output media passing in layers with the laminating film through the space between pressure roller and itself.
